(19) United States
(12) Patent Application Publication
(10) Pub. No.: US 2009/0069491 A1
(43) Pub. Date: Mar. 12, 2009

(54) PEROXIDE-FREE DIRECT GRAFTING OF POLAR MONOMERS ONTO UNSATURATED POLYOLEFINS

(75) Inventors: Chunxia Costeux, Midland, MI (US); Anthony C. Neubauer, Piscataway, NJ (US); Nathan J. Wiker, Houston, TX (US); Timothy J. Pope, Freeland, MI (US); William J. Michie, JR., Missouri City, TX (US)

Correspondence Address: The Dow Chemical Company, Intellectual Property Section, P.O. Box 1967, Midland, MI, 48641-1967, US

(73) Assignee: Dow Global Technologies Inc., Midland, MI (US)

(21) Appl. No.: 11/851,074

(22) Filed: Sep. 6, 2007

(51) Int. Cl. C08F 255/00

(52) U.S. Cl. 524/543; 525/72; 525/73; 525/78

(57) ABSTRACT

The present invention is a peroxide-free process for preparing a direct-grafted polyolefin. The process has the steps of (a) selecting an antioxidant-free, unsaturated polyolefin, (b) oxidizing the polyolefin, (c) selecting a graftable, polar monomer, (d) combining the polyolefin and the graftable, polar monomer, (e) forming free radicals on the oxidized polyolefin, and (f) grafting the graftable, polar monomer onto the polyolefin at the free-radical sites.

### FIELD OF THE INVENTION

This invention relates to processes for grafting polyolefins. Specifically, it relates to a process for peroxide-free direct grafting of polar monomers onto unsaturated polyolefins.

### DESCRIPTION OF THE PRIOR ART

Grafting polar groups such as maleic anhydride, acrylic acid, or silane onto non-polar polymeric chains is a common way to modify polymers, which is usually called functionalization of polymers. The coexistence of polar and non-polar groups in the functionalized polymers makes them useful as a compatibilizing agent to improve the compatibility of two substances, which are originally incompatible such as polyethylene and nylon.

Based on the saturation of chemical bonds in the base polymer, there are two common grafting mechanisms: “ene” reaction and radical initiated grafting. For example, maleic anhydride is grafted to unsaturated polymer chains, which contain carbon double bonds through the “ene” reaction and the double bond shifts. The “ene” reaction is completed by electron transfers between the two reactants. These reactions occur at temperatures as high as or greater than 300 degrees Celsius or involve the use of high-energy irradiation. As a result, a succinic anhydride moiety is appended to the polymer chains. No other additives are necessary for the reaction.

Under the radical-initiated grafting mechanism, maleic anhydride is grafted to saturated polymer chains under which produce macro-polymer radicals and maleic radicals. One way to produce these radicals is using high energy such as gamma radiation, UV radiation, or shock waves.

Another radical initiator mechanism uses organic peroxides. First, the peroxide decomposes into free radicals. Then, the peroxide free radicals react with polymer chains to produce polymer macro-radicals and convert the polar monomer to an excited dimer. Finally, the polymer macro-radical reacts with the excited dimer and forms grafted polymer chains.

It is desirable to have a process that grafts a polar monomer onto an unsaturated polyolefin, without relying on “ene” reaction or the addition of an organic peroxide. It is further desirable to effect the grafting at normal processing conditions (e.g., temperature) for the polyolefins. Additionally, it is desirable to minimize the number of steps necessary for handling and processing the grafted polyolefins.

It is desirable to achieve grafting levels of between 0.1 weight percent and 1.5 weight percent.

It is further desirable to prepare polyolefin-based composites made from or containing the direct-grafted polyolefin of the present invention.

### SUMMARY OF THE INVENTION

The present invention is a peroxide-free process for preparing a direct grafted polyolefin. The process has the steps of (a) selecting an antioxidant-free, unsaturated polyolefin, (b) oxidizing the polyolefin, (c) selecting a graftable, polar monomer, (d) combining the polyolefin and the graftable, polar monomer, (e) forming free radicals on the oxidized polyolefin, and (f) grafting the graftable, polar monomer onto the polyolefin at the free-radical sites.

### BRIEF DESCRIPTION OF DRAWING

FIG. 1 shows the Time Lapsed Changes in Mass Due to Moisture for non-talc containing compositions, including comparative examples and the examples of the present invention.

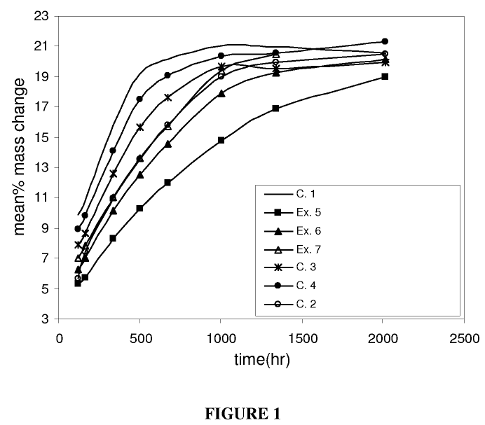

FIG. 2 shows the Time Lapsed Changes in Thickness Due to Moisture for non-talc containing compositions, including comparative examples and the examples of the present invention.

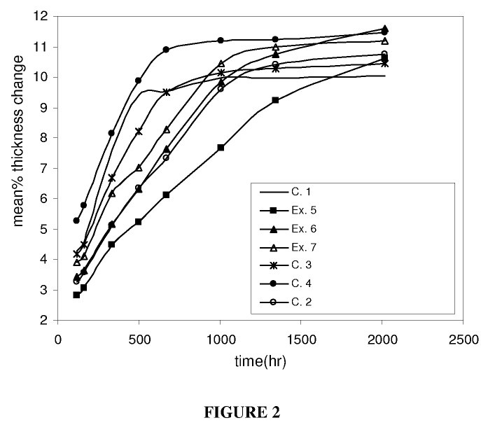

FIG. 3 shows the Time Lapsed Changes in Mass Due to Moisture for medium-talc containing compositions, including comparative examples and the examples of the present invention.

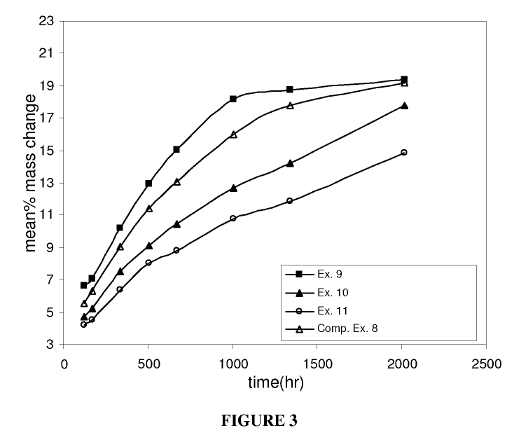

FIG. 4 shows the Time Lapsed Changes in Thickness Due to Moisture for medium-talc containing compositions, including comparative examples and the examples of the present invention.

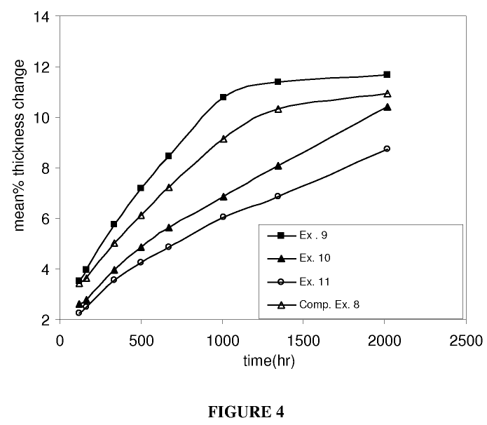

FIG. 5 shows the Time Lapsed Changes in Mass Due to Moisture for high-talc containing compositions, including comparative examples and the examples of the present invention.

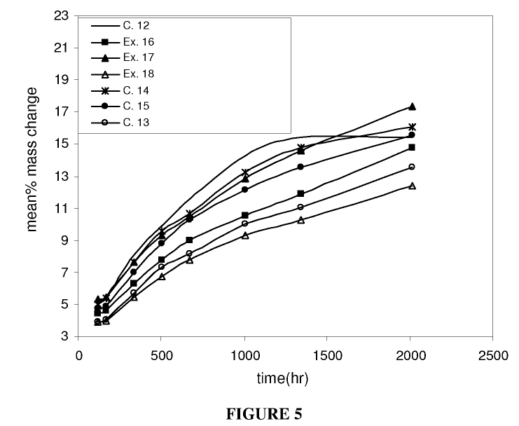

FIG. 6 shows the Time Lapsed Changes in Thickness Due to Moisture for high-talc containing compositions, including comparative examples and the examples of the present invention.

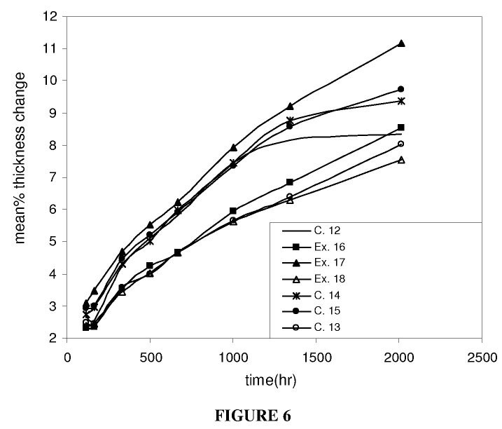

### DESCRIPTION OF THE INVENTION

In its preferred embodiment, the invented peroxide-free process for preparing a direct-grafted polyolefin comprises the steps of (a) selecting a polyolefin having unsaturation and being substantially free of antioxidants, (b) oxidizing the polyolefin, (c) selecting a graftable, polar monomer, (d) combining the polyolefin and the graftable, polar monomer, (e) forming free radicals on the oxidized polyolefin, and (f) grafting the graftable, polar monomer onto the polyolefin at the free-radical sites. The process is substantially free of organic peroxides. Preferably, there are no organic peroxides present.

Suitable polyolefins include ethylene polymers prepared with alkyl chromate catalysts, their variants, silyl chromate catalysts, their variants, chromium oxide catalysts, and their variants. More preferably, when the catalyst is a variant of silyl chromate, the catalyst will be bis(triphenylsilyl)chromate catalyst chemically reduced with diethyl aluminum ethoxide in various molar ratios to give 0.5 to 12 AlCr molar ratios. Suitable variants also include phenol-modified catalysts, where the substituted phenol are p-bromophenol, p-cresol, p-tertiarybutylphenol, p-hydroquinone, and β-napthol and the chromate is of the general formula CrO₂Y₂, where Y=alkoxy-, trialkylsiloxy, triarylsiloxy, or a halogen. Also more preferably, when the catalyst is a chromium oxide, the catalyst may be modified with tetraisopropyl titanate or ammonium silicofluoride.

The ethylene polymer may be a high density polyethylene, medium density polyethylene, and low density polyethylene, having vinyl, trans vinyl, and/or vinylidene groups.

Without being bound to any specific theory, it is believed that the level of unsaturation relates to the grafting reaction of the present invention. It is believed that the theoretical grafting limit can be calculated according to equal mole criterion. Furthermore, the number of carbon double bonds per 1000 carbon of a polymer can be measured using a nuclear magnetic resonance method.

Based upon that understanding, an appropriate polyolefin can be selected based upon the desired level of polar monomer grafting. It is further contemplated that the level of grafting may be controlled based upon the amount of polar monomer added during the invented process.

The polyolefin should be at least substantially free of any antioxidants. Preferably, the polyolefin would have no antioxidant present. For the present invention, it is desirable to oxidize the polyolefin such that oxidized polymer contains peroxide groups. It is particularly desirable to incorporate peroxide groups into the polymer chains. Antioxidants would inhibit the oxidization of the unsaturated polyolefin.

It is believed that several methods are known for oxidizing unsaturated polyolefins. For example, the combination of the carbon double bonds, absorbed oxygen (air), and purging/storage temperature will introduce oxidation reactions to the polymer and result in incorporating some peroxide groups. The amount of absorbed air, amount of carbon double bonds, storage time, and temperature will affect the degree of oxidation. Specifically, the unsaturated polyolefin can be oxidized by subjecting the polyolefin to an oxygen-containing environment, for an amount of time and at a suitable temperature to yield oxidation of the polyolefin. The efficiency of oxidizing the polyolefin may be improved when residual catalyst or other promoters are present.

However, it is preferable to manage the temperature of oxidation to avoid certain side reactions. In particular, it is preferable to perform the oxidizing step occurs at a temperature that permits the polyolefin to remain substantially free of crosslinking bonds or chain scissioning.

Preferably, air purging following combination of the polyolefin and the graftable, polar monomer in the reactive extruder should be avoided. The air purging can promote the competitive side reaction of crosslinking rather than introducing additional peroxide groups for grafting.

Suitable graftable, polar monomers may be ethylenically unsaturated carboxylic acids and ethylenically unsaturated carboxylic acid anhydrides, including derivatives of such acids, and mixtures thereof, and vinyl trialkoxy silanes. Examples of the acids and anhydrides, which may be mono-, di- or polycarboxylic acids, are acrylic acid, methacrylic acid, maleic acid, fumaric acid, itaconic acid, crotonic acid, itaconic anhydride, maleic anhydride and substituted maleic anhydride, e.g., dimethyl maleic anhydride or citraconic anhydride, nadic anhydride, nadic methyl anhydride and tetrahydro phthalic anhydride. Examples of derivatives of the unsaturated acids are salts, imides, amides and esters, e.g., mono- and disodium maleate, acrylamide, maleimide, glycidyl methacrylate and diethyl fumarte. Examples of the vinyl trialkoxy silanes are vinyl trimethoxy silane and vinyl triethoxy silane.

Without being bound to any specific mechanism, it is observed that the free radicals can be formed on the oxidized polyolefin by heating the oxidized polyolefin.

In another preferred embodiment, the present invention is a process for preparing a grafted polyolefin comprising the steps (a) selecting an oxidized polyolefin; (b) selecting a graftable, polar monomer; (c) combining the oxidized polyolefin and the graftable, polar monomer; (d) forming free radicals on the oxidized polyolefin; and (e) grafting the graftable, polar monomer onto the oxidized polyolefin at the free-radical sites. Suitable oxidized polyolefins are derived from the oxidization of unsaturated ethylene polymers prepared with alkyl chromate catalysts, their variants, silyl chromate catalysts, their variants, chromium oxide catalysts, and their variants.

WO 2005/116091 teaches a method for preparing a polyolefin with enriched peroxide content via reactivation. That reference is incorporated herein by reference.

In yet another embodiment, the present invention is a peroxide-free process for preparing a direct-grafted polyolefin comprising the steps of (a) selecting an oxidized polyolefin, (b) selecting a graftable, polar monomer, (c) admixing in an extruder the oxidized polyolefin and the graftable, polar monomer, (d) heating the mixture to a temperature suitable for free-radically activating the oxidized sites on the polyolefin, (e) grafting the polar monomer onto the polyolefin at the oxidized sites, and (f) extruding direct-grafted polyolefin from the extruder.

In another embodiment, the present invention is a direct-grafted polyolefin prepared by any of the described methods.

In yet another embodiment, the present invention is a polyolefin-based composition made from or containing the direct-grafted polyolefin and at least one additive. The composition may contain more than one direct-grafted polyolefin and/or more than one additive.

In a preferred embodiment, the present invention is a bio-fiber-plastic composite formulation containing or made from the direct-grafted polyolefin and a bio-fiber component. Suitable bio-fiber components include wood, hemp, kenaf, rice hulls, wheat straw, and other cellulosic materials. The bio-fiber component may be present any amount up to about 90 weight percent.

The bio-fiber plastic composite formulation may also contain other polymeric materials such as high density polyethylene, low density polyethylene, linear low density polyethylene, polypropylene, polyvinyl chloride, acrylonitrile butadiene styrene polymers, or other polymers. These polymeric materials may be present in an amount up to about 90 weight percent. Preferably, they are present in an amount between about 30 and about 70 weight percent.

Other additives include talc and inorganic fillers, processing aids, coupling aids, pigments, antioxidants, microbial additives, and flame retardants. Talc and inorganic fillers may be present in an amount up to about 20 weight percent. The processing aids include metallic stearates, waxes, amides, and other materials, which may be present in an amount up to about 6 weight percent. Coupling agents include, for example, maleic anhydride grafted polymers and silane grafted polymers, which may be present in an amount up to about 6 weight percent. Pigments, antioxidants, and microbial additives are generally present in an amount less than about 5 weight percent.

### EXAMPLES

The following non-limiting examples illustrate the invention.

### Test Methods

The following test methods were used to evaluate the examples:

(1) Modulus of Elasticity (“MOE”) and Modulus of Rupture (“MOR” or Flexural Strength)

Both the modulus of elasticity and the modulus of rupture were measured according to ASTM D790, “Flexural Properties of Unreinforced and Reinforced Plastics and Electrical Insulating Materials.” The specimens had a width of 1.0 inch (25.4 mm) and a length of 6 inch (152 mm). The thickness of the specimen was targeted at 0.25 inch (6.4 mm), and the support span was set at 4 inch (102 mm), yielding a 16:1 L/D ratio as required by the ASTM testing protocol. The testing was conducted in a standard room temperature of 23 degrees Celsius and 50 percent humidity.

(2) Moisture Resistance (or Mass and Thickness Changes Due to Moisture)

The moisture resistance was measured according to ASTM D570-98, “Standard Test Method for Water Absorption of Plastics,” by using a rectangular bar in dimensions of 1 inch×4 inch×0.25 inch (25.4 mm×102 mm×6.4 mm) (W×L×T). As required by the testing method, a set of 3 specimens was prepared for each sample. The weight of each bar was measured and recorded prior to submerging in water. The bars were placed upright in a bucket filled with water. The weight and dimensions of each specimen were recorded at successive intervals of time. The percentage change of mass and volume were recorded and plotted.

### The Exemplified Compositions

Compositions were evaluated at three different talc levels: (1) none; (2) medium—5 weight percent; and (3) high—14 weight percent. The talc used was Luzenac Nicron 403, which had an approximate average particle size of 0.5 micron and was supplied by Rio Tinto Minerals. The following components were used to prepare the compositions:

(a) Amplify GR205™ maleic anhydride grafted high density polyethylene, having a melt index of 2.0 gram per 10 minute (measured at 190 degrees Celsius, 2.16 kilogram), a density of 0.965 gram per cubic centimeter, and a maleic anhydride grafting level of 1.2 weight percent. The polymer was commercially available from The Dow Chemical Company.

(b) Direct-grafted polyethylene, being based upon a polyethylene having a density of 0.945 gram per cubic centimeter and a melt index of 0.8 gram per 10 minute (measured at 190 degrees Celsius, 2.16 kilogram), and having maleic anhydride grafted at 0.7 weight percent.

(c) Polybond 3009™ maleic anhydride grafted high density polyethylene, having of 5.0 gram per 10 minute (measured at 190 degrees Celsius, 2.16 kilogram), a density of 0.95 gram per cubic centimeter, and a maleic anhydride grafting level of 1.2 weight percent. The polymer was commercially available from Chemtura (Crompton-Uniroyal Chemical).

(d) Lotader 3210™ random terpolymer of ethylene, butyl acrylate, and maleic anhydride, having a melt index of 5 gram per 10 minute (measured at 190 degrees Celsius and under 2.16 kilogram), a density of 0.94 gram per cubic centimeter, and a maleic anhydride grafting level of 3 weight percent. The butyl acrylate component was present in an amount of 5 weight percent. It was commercially available from Arkema.

(e) Wood flour (60-mesh particle-size pine) was commercially available from American Wood Fiber.

(f) High density polyethylene, having a melt index of 0.48 gram per 10 minute (measured at 190 degrees Celsius and under 2.16 kilogram) and a density of 0.953 gram per cubic centimeter. The high density polyethylene was commercially available from The Dow Chemical Company.

(g) Struktol TPW 113™ processing aid, being a blend of a complex, modified fatty acid ester and having a specific gravity of 1.005, was commercially available from Struktol Company of America.

(h) Struktol TPW 104™ processing aid, being a blend of aliphatic carboxylic acid salts and mono and diamides, was commercially available from Struktol Company of America.

The amount of components utilized to make the non-talc formulations are shown in Table 1. Table 1 also recites the values determined for the physical properties of elastic modulus and rupture modulus.

TABLE 1

| Component | C. 1 | C. 2 | C. 3 | C. 4 | Ex. 5 | Ex. 6 | Ex. 7 |
|---|---|---|---|---|---|---|---|
| Amplify GR205 | | 2 | | | | | |
| Polybond 3009 | | | 2 | | | | |
| Lotader 3210 | | | | 2 | | | |
| Direct-Grafted PE | | | | | 2 | 3 | 4 |
| Wood Flour | 60 | 60 | 60 | 60 | 60 | 60 | 60 |
| HDPE | 37 | 35 | 35 | 35 | 35 | 34 | 33 |
| TPW113 | | 3 | 3 | 3 | 3 | 3 | 3 |
| TPW104 | 3 | | | | | | |

Physical Properties, pound per square inch (MPa)

| | | | | | | | |
|---|---|---|---|---|---|---|---|
| MOE | 481940 (3323) | 511586 (3527) | 454478 (3134) | 432271 (2981) | 511450 (3526) | 543581 (3748) | 541240 (3732) |
| MOR | 3486 (24) | 4495 (31) | 3403 (23) | 3222 (22) | 4680 (32) | 4721 (33) | 4875 (34) |

The amount of components utilized to make the medium talc formulations are shown in Table 2. Table 2 also recites the values determined for the physical properties of elastic modulus and rupture modulus.

TABLE 2

| Component | Comp. Ex. 8 | Ex. 9 | Ex. 10 | Ex. 11 |
|---|---|---|---|---|
| Amplify | 2 | | | |
| GR205 | | | | |
| Direct-Grafted | | 2 | 3 | 4 |
| PE | | | | |
| Wood Flour | 55 | 55 | 55 | 55 |
| HDPE | 34 | 34 | 33 | 32 |
| TPW113 | 4 | 4 | 4 | 4 |

Physical Properties, pounds per square inch (MPa)

| | | | | |
|---|---|---|---|---|
| MOE | 554546 | 585629 | 585713 | 630587 |
| | (3842) | (4038) | (4038) | (4348) |
| MOR | 4455 | 4026 | 4513 | 4637 |
| | (31) | (28) | (31) | (32) |

The amount of components utilized to make the high talc formulations are shown in Table 3. Table 3 also recites the values determined for the physical properties of elastic modulus and rupture modulus.

TABLE 3

| Component | C. 12 | C. 13 | C. 14 | C. 15 | Ex. 16 | Ex. 17 | Ex. 18 |
|---|---|---|---|---|---|---|---|
| Amplify GR205 | | 2 | | | | | |
| Polybond 3009 | | | 2 | | | | |
| Lotader 3210 | | | | 2 | | | |
| Direct-Grafted PE | | | | | 2 | 3 | 4 |
| Wood Flour | 45 | 45 | 45 | 45 | 45 | 45 | 45 |
| HDPE | 35.5 | 33.5 | 33.5 | 33.5 | 33.5 | 32.5 | 31.5 |
| TPW113 | | 5.5 | 5.5 | 5.5 | 5.5 | 5.5 | 5.5 |
| TPW104 | 5.5 | | | | | | |

Physical Properties, pounds per square inch (MPa)

| | | | | | | | |
|---|---|---|---|---|---|---|---|
| MOE | 527211 (3635) | 595393 (4105) | 625410 (4312) | 598706 (4128) | 564162 (3890) | 603044 (4158) | 587491 (4051) |
| MOR | 3173 (22) | 4335 (30) | 4176 (29) | 3753 (26) | 4141 (29) | 4332 (30) | 4521 (31) |

What is claimed is:

1. A peroxide-free process for preparing a direct-grafted polyolefin comprising the steps
(a) selecting a polyolefin having unsaturation and being substantially free of antioxidants;
(b) oxidizing the polyolefin;
(c) selecting a graftable, polar monomer;
(d) combining the polyolefin and the graftable, polar monomer;
(e) forming free radicals on the oxidized polyolefin; and
(f) grafting the graftable, polar monomer onto the polyolefin at the free-radical sites,
wherein the process is substantially free of organic peroxides.

2. The process of claim 1 wherein the polyolefin is oxidized by subjecting the polyolefin to an oxygen-containing environment, for an amount of time and at a suitable temperature to yield oxidation of the polyolefin.

3. The process of claim 1 wherein the oxidizing step occurs at a temperature that permits the polyolefin to remain substantially free of crosslinking bonds or chain scissioning.

4. The process of claim 1 wherein the free radicals form on the oxidized polyolefin by heating the oxidized polyolefin.

5. The process of claim 1 wherein the unsaturated polyolefins is selected from the group consisting of chrome-catalyzed high density polyethylene, and . . .

6. The process of claim 1 wherein the graftable, polar monomer is selected from the group consisting of ethylenically unsaturated carboxylic acids, ethylenically unsaturated carboxylic acid anhydrides, vinyl trialkoxy silanes, and derivatives thereof.

7. The process of claim 4 wherein the graftable, polar monomer is selected from the group consisting of acrylic acid, methacrylic acid, maleic acid, fumaric acid, itaconic acid, crotonic acid, itaconic anhydride, maleic anhydride, substituted maleic anhydride, mono sodium maleate, disodium maleate, acrylamide, maleimide, glycidyl methacrylate, diethyl fumarte, vinyl trimethoxy silane, and vinyl triethoxy silane.

8. A peroxide-free process for preparing a direct-grafted polyolefin comprising the steps
(a) selecting an oxidized polyolefin;
(b) selecting a graftable, polar monomer;
(c) combining the oxidized polyolefin and the graftable, polar monomer;
(d) forming free radicals on the oxidized polyolefin; and
(e) grafting the graftable, polar monomer onto the oxidized polyolefin at the free-radical sites,
wherein the process is substantially free of organic peroxides.

9. A peroxide-free process for preparing a direct-grafted polyolefin comprising the steps
(a) selecting an oxidized polyolefin;
(b) selecting a graftable, polar monomer;
(c) admixing in an extruder the oxidized polyolefin and the graftable, polar monomer;
(d) heating the mixture to a temperature suitable for free-radically activating the oxidized sites on the polyolefin;
(e) grafting the polar monomer onto the polyolefin at the oxidized sites; and
(f) extruding direct-grafted polyolefin from the extruder,
wherein the process is substantially free of organic peroxides.

10. A direct-grafted polyolefin prepared according to the process of any of claims 1-9.

11. A direct-grafted polyolefin comprising:
(a) an oxidized polyolefin and
(b) a polar monomer being peroxide-free, free-radical grafted onto the oxidized polyolefin.

12. A polyolefin-based composition comprising
(a) a direct-grafted polyolefin and
(b) an additive.

13. A bio-fiber-plastic composite comprising:
(a) a direct-grafted polyolefin and
(b) a bio-fiber component.
